(19) United States
(12) Patent Application Publication
(10) Pub. No.: US 2020/0077683 A1
(43) Pub. Date: Mar. 12, 2020

(54) PROCESS OF PREPARING A MOLDED 3-DIMENSIONAL SELF-CONTAINED SINGLE SERVING PASTA FOOD PRODUCT

(71) Applicant: Luigi FIORENTINO, Brooklyn, NY (US)

(72) Inventor: Luigi FIORENTINO, Brooklyn, NY (US)

(21) Appl. No.: 16/609,536

(22) PCT Filed: May 2, 2018
(86) PCT No.: PCT/US2018/030611

§ 371 Date: Oct. 30, 2019

Related U.S. Application Data
(60) Provisional application No. 62/593,028, filed on Nov. 30, 2017.
(60) Provisional application No. 62/500,523, filed on May 3, 2017.
(60) Provisional application No. 62/500,525, filed on May 3, 2017.
(60) Provisional application No. 62/500,538, filed on May 3, 2017.

(51) Int. Cl. A23L 7/109; A23P 30/10; A23L 7/126

(52) U.S. Cl. CPC A23L 7/11; A23V 2002/00; A23L 7/126; A23P 30/10

(57) ABSTRACT

A process for preparing a self-contained single serving pasta food product includes: cooking a predetermined amount of pasta until hydrated to 45%-50% of its specific weight 45%-50% of its specific weight; cooling the pasta in water at a temperature between 20 and 40 degrees Celsius; creating a plasticizing water-based film surrounding the cooked pasta; adding an accompaniment to the pasta to create a mixture; adding the mixture to a mold; heating the molded mixture; and removing the heated molded mixture from the mold.

### INCORPORATION BY REFERENCE

This application claims benefit of U.S. Provisional Patent Applications No. 62/593,028, filed Nov. 30, 2017; 62/500,538, May 3, 2017; 62/500,525, filed May 3, 2017; and 62/500,523, filed May 3, 2017, the entire contents of all of which are included herein by reference as if fully set forth.

### BACKGROUND

Pasta is a food item generally made from a dough mixture of flour, derived from grinding hard grains such as wheat, rice or corn, (or flours derived from grinding dehydrated tubers or legumes), water, and (optionally) eggs. In making spaghetti, a very popular form of pasta, the dough is formed into string shaped lengths of varying thickness or diameter, which after being boiled in water, is dressed or garnished with any of the following: a sauce; condiments; oil; spices; seasoning; meat, fish or seafood pieces; cheese, or combinations thereof, thereby resulting in a spaghetti food preparation.

Pasta food preparations are eaten from a plate, bowl or other container. The dressed spaghetti is made up of loosely amassed solids, semi-solids and liquids and must be consumed with utensils, forks, spoons, chop sticks or other implements. Pasta is a widely consumed food items worldwide and enjoys mass appeal. A pasta food preparation can be made in various quantities or yields for one or more persons and can be prepared by any average individual, a skilled professional, or produced commercially or industrially and commercially packaged. The practicality of eating a pasta preparation, including portability, is always restricted to either one or more of the following: preparation restrictions and limitations; container availability and ease of transport; utensil requirements and clean up issues.

### SUMMARY

The process of preparing the 3-dimensional self-contained single serving pasta food product according to the present disclosure includes molding or forming by various different methods, a pasta, in particular a spaghetti food preparation into a single serving format food product having any number combination of constituent pieces and/or accompaniments resulting in a self-contained 3-dimensional single serving format. This format allows a consumer to consume it by themselves under typical circumstances directly from their hand not necessarily requiring a container, vessel or utensils and involves little or no clean up issues as otherwise could not have been achieved by existing spaghetti food preparation.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is an isometric view of the pasta food product of the present process;

FIG. 2 is a section view of the pasta food product of FIG. 1; and

FIG. 3 is a flow diagram of the process.

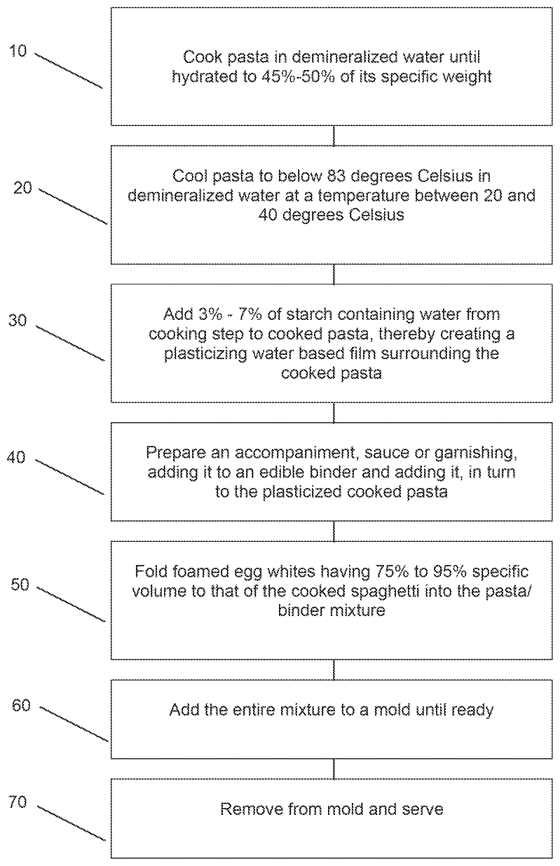

### DETAILED DESCRIPTION OF THE PREFERRED EMBODIMENTS

Noodles of any length, diameter or thickness, in dried format with a water activity (aw) in a range between 0.4 to 0.6, preferably 0.5, are used. Water activity (aw) being defined as the partial vapor pressure of water in a substance divided by the standard state partial vapor pressure of water. In the field of food science, the standard state is most often defined as the partial vapor pressure of pure water at the same temperature. The preferred type of noodle is commercially produced pasta or dry spaghetti noodles made from durum wheat semolina having a preferred thickness diameter range of approximately 0.8 mm to 1.7 mm and a preferred length of 25 to 40 cm and even more preferably at least 15 cm in length. It should be noted however, that pasta having other shapes, diameters, and lengths can also be used, e.g. acini, alphabet, anelli, bigoli, ditalini, farfalline, orso, pici, spaghettini, stelline, etc. It has been discovered that pasta having a surface curvature is required in order to obtain the necessary surface adhesion or binding qualities.

The dry noodles are heated in an aqueous solution, preferably water and more preferably demineralized water, purified water, or water treated by a reverse osmosis system, to a temperature between approximately 83 degrees Celsius and 105 degrees Celsius. In the heating and hydration step 10, a quantity of water that is preferably 300% to 400% of the specific weight to that of the dry noodles, is brought to a rolling boil.

The heated and hydrated noodles 5 should be prepared to an adequate texture in which they are preferably hydrated to between 45% to 50% of their specific weight in order to achieve a desired starch release on the surface of the noodles and to create an adequate binding surface of the noodles in the subsequent process steps. It has been discovered that beyond this range too much starch is released from the protein matrix of the noodle 5. Moreover, in addition to too much starch being released, when hydrated beyond the above range, release of diffused starch only on the outer surface cannot be maintained, which would ruin the plasticization bond discussed below. At the time of the of starch release, which occurred in the heating and hydration of the noodle, the heated and hydrated noodles 5 are completely removed from the aqueous solution in which the noodle was heated, and the aqueous solution (i.e., starch containing water) should be set aside for a subsequent process step.

The noodles are then be placed in a second, cool aqueous solution, preferably water and more preferably demineralized water, purified water, or water treated by a reverse osmosis system, having a preferable temperature range from 20 degrees Celsius to no more than 40 degrees Celsius in a cooling step 20, in order to quickly lower the noodle temperature below 83 degrees Celsius to halt further release of starch from the noodle protein matrix and to maintain the surface starch released in the heating and hydration process while preventing retrogradation of the surface starch back into the noodle or to detach from the noodle surface which occurs as temperatures decrease. This desired state now obtained by the starch released on the outer surface of the noodle creates an ideal physical and structural inner noodle state and an ideal physical property state of the outer noodle (stabilized heated and hydrated noodle) which is critical in the subsequent process steps.

An edible garnishing or accompaniment can be optionally added to the noodles in a subsequent step 40. Exemplary edible garnishing or accompaniments can be prepared by including any combination of the following constituents: a prepared sauce; vegetables; legumes; condiments; plant derived oils; salt; spices; seasoning; meat; fish or seafood pieces; and cheese. One of ordinary skill in the art would readily recognize that the edible garnishing or accompaniment is not limited to the foregoing constituents, and can include other constituents depending on the desired flavor. The various derivative of flavors and/or recipe mixtures can result in a variety of prepared yield options for the resulting. The resulting edible garnishing mixture preferably contains a water activity (aw) in the range between 0.7 aw and 0.98 aw. This garnishing or accompaniment mixture is set aside for subsequent garnishing process steps.

The stabilized heated and hydrated noodle prepared in the previous step 20 is drained from the second aqueous solution and introduced, in a subsequent step 30, to an aqueous solution containing 3% to 7% of starch, which can be the starch containing water previously set aside, which is heated to temperature between 83 degrees and 90 degrees. The starch in the heated starch containing aqueous solution adheres to the suspended state starch on the outer surface of the noodle to create a plasticizing water based film surrounding the noodles which protects the noodles to maintain the desired moisture and consistency desired in the noodle. The plasticized surface wet noodle is set aside for a subsequent process step.

The garnishing or accompaniment is now introduced to an edible amphiphillic binder such as lecithin, preferably obtained from egg yolk 40. Other binders such as soy lecithin and other emulsifiers can also be used. The amphiphillic properties of lecithin attract both water and fatty substances which are the constituents of the garnishing.

The plasticized surface wet noodle set aside in the previous step is now introduced to the garnishing or accompaniment 45 with lecithin, or just a lecithin preparation alone. The amphiphilic properties of lecithin bind to the surface water of the noodle and the garnishing constituents. However, the amphiphilic emulsifying properties of the egg yolk will not be able to drain moisture content from the inner core of the noodle because of the plasticized outer surface achieved.

At this stage of the process, a mixture of foam egg whites having 75% to 95% specific volume to that of the noodles and garnishing are folded into the entire mixture to create a heat activated expanding filling agent in a further step 50.

The entire mixture is placed into food grade molds, preferably food grade silicone, step 60. The molds are all-encompassing closed molds designed to yield a 3-dimensional handheld shape in which the resulting mixture must be filled to less than capacity to permit the mixture containing the egg white foam and resulting mixture to expand to completely fill out the inner cavity upon heating the filled molds in an oven. The mold is preferably round, toroidal or donut-shaped; however, one of skill in the art will readily recognize various mold shapes can be used within the scope of this disclosure. The water loss desired to achieve a desired water activity can be achieved by modulating the heating temperatures and controlling mold venting while being heated, step 60. The shortest heating duration to achieve the required internal temperature, dependent on local food safety guidelines, is preferred.

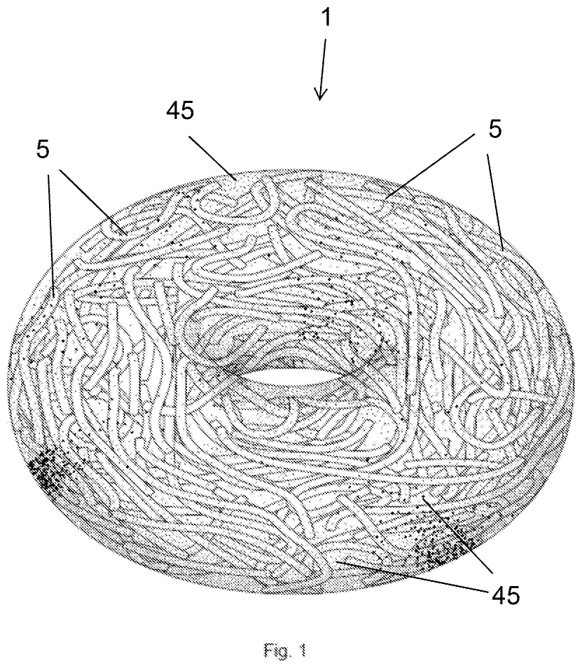

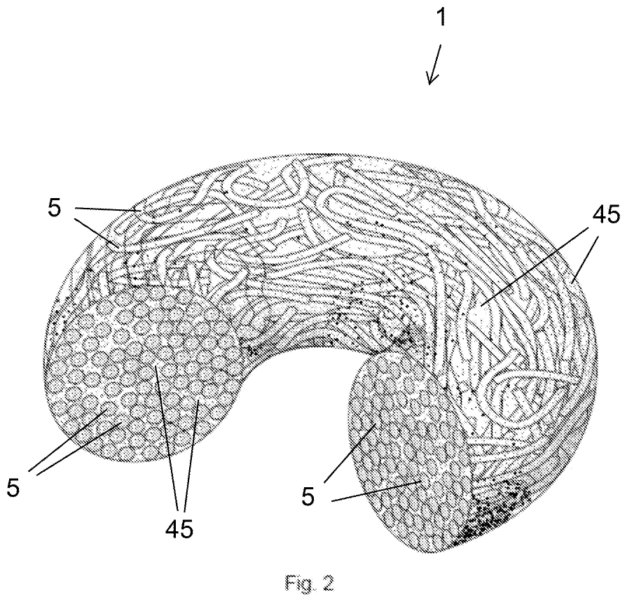

The heating duration of the mixture will be determined on various factors dependent on the garnishing type and on standardized food safety norms. After heating, the mixture is removed from the mold, step 70, and the resulting process yields a hand-held noodle based product in a 3-dimensional form. The resulting noodle based food product 1, as depicted in FIG. 1, is sufficiently dried and has a desirable water activity (a_{w}) such that it can used or consumed in a hand held fashion without fracturing apart or leaving behind a mess of fractured components in a user or consumer's hands. As shown in the section view of FIG. 2, the noodles 5 are maintained in position by the garnishing or accompaniment and the binder material 45.

After removing the resulting noodle based food product 1 from the mold, one or more of the following procedures can optionally be implemented for serving or preservation: subsequent heat exposure resulting in browning; baking; frying; open flame exposure; drying; vacuum packing; smoking; flash freezing; freezing to below −8 degrees Celsius to prevent starch retrogradation.

The molded noodle based food product 1 in single serving format can be produced in a single or high volume continuous batch quantity fashion via a combined or unique method of the following: manual, mechanized, commercial or industrial manner.

In an alternate embodiment, a stick, or similar type insertable item or element is introduced into the moldable pasta preparation either prior to or post molding. The stick, or similar type insertable item introduced to the molded pasta preparation can be made of a food grade material that has a shape profile which provides a handle for a consumer to grasp the moldable pasta preparation, thereby facilitating consumption.

It is understood, therefore, that this invention is not limited to the particular embodiments disclosed, but is intended to cover all modifications which are within the spirit and scope of the invention as defined by the appended claims; the above description; and/or shown in the attached drawings.

### EMBODIMENTS

1. A process for preparing a self-contained single serving pasta food product (1) comprising:
cooking a predetermined amount of pasta until hydrated to 45%-50% of its specific weight (10);
cooling the pasta to below 83 degrees Celsius in water at a temperature between 20 and 40 degrees Celsius (20);
creating a plasticizing water-based film surrounding the cooked pasta (30);
adding an accompaniment to the pasta to create a mixture (40);
adding the mixture to a mold (60);
heating the molded mixture (60); and
removing the heated molded mixture from the mold (70).

2. The process of embodiment 1, wherein the plasticizing water-based film is created by adding 3%-7% of starch containing water from the cooking step to the cooked pasta.

3. The process of embodiment 1 or 2, wherein the accompaniment comprises an edible binder.

4. The process of any of the previous embodiments, wherein the edible binder comprises lecithin.

5. The process of any of the previous embodiments, wherein the accompaniment comprises an amphiphilic edible binder.

6. The process of any of the previous embodiments, wherein egg whites having 75% to 95% specific volume to that of the cooked pasta are folded into the mixture prior to adding the mixture to the mold.

7. The process of any of the previous embodiments, wherein the pasta is a type of pasta selected from the group consisting of: acini, alphabet, anelli, bigoli, ditalini, farfalline, orso, pici, spaghetti, spaghettini, stelline and combinations thereof.

8. The process of any of the previous embodiments, wherein the self-contained pasta food product is further processed by: baking; frying; open flame exposure; drying; vacuum packing; smoking; or flash freezing.

9. The process of any of the previous embodiments, wherein the mold is round, toroidal or donut-shaped.

10. The process of any of the previous embodiments, wherein the heated molded mixture is round, toroidal or donut-shaped.

11. A self-contained single serving pasta food product made by the process of any of the previous embodiments.

What is claimed is:

1. A process for preparing a self-contained single serving pasta food product (1) comprising:
cooking a predetermined amount of pasta until hydrated to 45%-50% of its specific weight (10);
cooling the pasta to below 83 degrees Celsius in water at a temperature between 20 and 40 degrees Celsius (20);
creating a plasticizing water-based film surrounding the cooked pasta (30);
adding an accompaniment to the pasta to create a mixture (40);
adding the mixture to a mold (60);
heating the molded mixture (60); and
removing the heated molded mixture from the mold (70).

2. The process of claim 1, wherein the plasticizing water-based film is created by adding 3%-7% of starch containing water from the cooking step to the cooked pasta.

3. The process of claim 1, wherein the accompaniment comprises an edible binder.

4. The process of claim 3, wherein the edible binder comprises lecithin.

5. The process of claim 1, wherein the accompaniment comprises an amphiphilic edible binder.

6. The process of claim 1, wherein egg whites having 75% to 95% specific volume to that of the cooked pasta are folded into the mixture prior to adding the mixture to the mold.

7. The process of claim 1, wherein the pasta is a type of pasta selected from the group consisting of: acini, alphabet, anelli, bigoli, ditalini, farfalline, orso, pici, spaghetti, spaghettini, stelline and combinations thereof.

8. The process of claim 1, wherein the self-contained pasta food product is further processed by: baking; frying; open flame exposure; drying;
vacuum packing; smoking; or flash freezing.

9. The process of claim 1, wherein the mold is round, toroidal or donut-shaped.

10. The process of claim 1, wherein the heated molded mixture is round, toroidal or donut-shaped.

11. A self-contained single serving pasta food product made by the process of claim 1.
